(19) United States
(12) Patent Application Publication
(10) Pub. No.: US 2013/0132242 A1
(43) Pub. Date: May 23, 2013

(54) Method for Providing Bookkeeping Service

(71) Applicant: Hei Tao Fung, Fremont, CA (US)

(72) Inventor: Hei Tao Fung, Fremont, CA (US)

(21) Appl. No.: 13/300,671

(22) Filed: Nov. 21, 2011

(51) Int. Cl. G06Q 40/00

(52) U.S. Cl. 705/30

(57) ABSTRACT

A method for providing bookkeeping service is disclosed. The method, facilitated by a bookkeeping server, addresses some security concerns arisen from using remote bookkeepers using techniques comprising: secure client sessions, work item distribution, organization information concealment, encryption using organization specific private keys, concealment of passwords, and distributed storage. Also, an image capturing system is disclosed. The image capturing system facilitates the process of capturing images of financial transactions for remote bookkeeping. It comprises a low-cost device that provides illumination and facilitates image processing working along with a smart phone.

### FIELD OF THE INVENTION

The present invention relates to providing bookkeeping service in a secure way.

### BACKGROUND

Bookkeeping is the recording of financial transactions that include sales, purchases, income, receipts and payments by an individual or organization. In the normal course of business, a document is produced each time a financial transaction occurs. Sales and purchases usually have invoices or receipts. Deposit slips are produced when deposits are made to a bank account. Checks are written to pay money out of a bank account. Bookkeeping involves recording the details of all those documents. Sometimes, the documents are in printed form or even in written form. Sometimes, they are computer generated. Bookkeeping is usually performed by a bookkeeper. With the recent technological advancement, some organizations hire remote bookkeepers in lieu of full-time, in-house bookkeepers. For example, clerks of an organization may scan documents of financial transactions and upload them to a server. The contracted remote bookkeepers access the server remotely and process the documents. Despite the cost savings that using remote bookkeepers may bring, many organizations still prefer keeping bookkeeping in-house. A primary reason is security concern or the fear of leaking sensitive financial information to outsiders. In this disclosure, we present a method of providing bookkeeping service with focus on addressing some security concerns. We also present a system that facilitates capturing images of financial transactions for employing the method disclosed.

### SUMMARY OF THE INVENTION

The object of this invention is a method for providing bookkeeping service for a number of organizations by a number of remote bookkeepers with some security concerns addressed.

The method requires facilitation of a bookkeeping server that both authorized clerks of organizations and remote bookkeepers can access via the Internet. The general workflow comprises the following steps: authorized clerks of organizations upload work items produced by general clerks of the organizations to the bookkeeping server; remote bookkeepers process the work items on the bookkeeping server; and the authorized clerks approve the processed work items.

Security concerns of using remote bookkeepers are addressed using a suite of techniques comprising: (1) secure client sessions (2) work item distribution; (3) organization information concealment; (4) encryption using organization specific private keys; (5) concealment of passwords; and (6) distributed storage. Those techniques are implemented with the facilitation of the bookkeeping server.

There are a few distinct techniques and associated advantages offered in this invention compared to what may be being practiced today. Some techniques are meant to hide as much information as possible from remote bookkeepers lest they would use the information for personal gain. Firstly, the bookkeeping server distributes work items to remote bookkeepers in such a way that a remote bookkeeper receives work items from a number of organizations and a remote bookkeeper never receives all work items from one organization. The purpose is not to have a remote bookkeeper possess complete knowledge about an organization. It is more difficult for a remote bookkeeper to make sense of partial knowledge for personal gain. Secondly, the bookkeeping server blocks out the information about the organization when displaying an image of a financial transaction record as a work item to a remote bookkeeper. For example, a work item is an invoice from a supplier to an organization. The name and address of the organization is known to the bookkeeping server as the work item is uploaded by authorized clerks of the organization. The bookkeeping server can perform optical character recognition (OCR) on the image of the work item and identify the portion of the image that contains the name and address of the organization. Then the bookkeeping server blocks out that portion of the image when displaying the image to a remote bookkeeper. The bookkeeping server can easily associate the processed work item to the organization. On the other hand, it is more difficult for a remote bookkeeper to make sense of the financial transaction record for personal gain.

There are some techniques aiming at protecting information of organization from perpetrators who somehow have gained access to the bookkeeping server. Firstly, the authorized clerks are to supply a pair of public key and private key to the bookkeeping server via a secure client session. The bookkeeping server shall keep the private key briefly but keep the public key permanently. The bookkeeping server keeps a database for each organization. Each database is encrypted using the public key supplied by the authorized clerks of the organization. Accessing the encrypted database requires the private key for decryption. The bookkeeping server encrypts the work items uploaded by the authorized clerks using a key generated by the bookkeeping server and saves the encrypted work items for the remote bookkeepers to process. When the remote bookkeepers are ready to process the work items, the bookkeeping server decrypts the work items using the key generated by the bookkeeping server and presents the work items to the remote bookkeepers. After the remote bookkeepers process the work items, the bookkeeping server encrypts the processed work items using the public key of the organization and saves the processed work items for the authorized clerks to approve. When the authorized clerks are ready to approve the processed work items, the bookkeeping server decrypts the processed work items and the database using the private key supplied by the authorized clerks. After the approval of the work items, the bookkeeping server updates the database and encrypts the database using the public key. The bookkeeping server needs and caches the private key only during the authorized clerks uploading the work items, approving the processed work items, or accessing the database. The private key is never stored outside the context of the secure client session. Therefore, the perpetrators are not able to access the database of any organization. Even if one database of an organization is compromised in security, the databases of other organizations are still protected.

Secondly, the bookkeeping server comprises a computing cluster capable of distributed processing and distributed storage in our preferred embodiment. For example, the bookkeeping server runs its software over the Hadoop framework. A number of parts of the database of any organization are spread across a number of computers in the computing cluster. Even if a computer in the computing cluster is compromised in security, not the whole database is compromised.

We further present an image capturing system for facilitating remote bookkeeping service. The image capturing system is meant to be low-cost. It comprises a smart phone and a holder of the smart phone. Many people purchase smart phones for multiple purposes. Smart phones comprise high resolution camera, networking capability, and text editing capability. They can be leveraged to capture images of financial transaction records. Capturing document images using camera is faster than capturing document images using a scanner. On the other hand, the lighting control is often a challenge. Document images captured by camera of smart phone often exhibit shades and uneven lighting. The image capturing system herein is meant to alleviate the problem.

The image capturing system comprises a basket that can contain a letter-sized or legal-sized document. The basket has four sidewalls. There are lights along the sidewalls to provide illumination to a document placed inside the basket. The lights are controlled by the smart phone via an electronic device on the basket. The smart phone is clamped to an elbow stabilized on the basket such that the smart phone can capture an image of the basket and the document placed inside without having users holding the smart phone. Image capturing software running on the smart phone can detect when a user is putting a new document inside the basket and automatically turns on the lights on the sidewalls of the basket and captures an image.

Furthermore, the basket is designed to facilitate image processing performed by image capturing software on the smart phone. The basket's bottom is in a non-white solid color, e.g., yellow, whereas the basket's sidewalls are in a different non-white solid color, e.g., green. When the image capturing software captures an image of the basket and the document therein, the image may include the sidewalls and the bottom, especially when the document is smaller than the basket. The image capturing software can easily identify the portion of the image that represents the bottom and the sidewalls, due to their unique colors, and crop the image to a minimal size that contains the document only.

### BRIEF DESCRIPTION OF THE DRAWINGS/FIGURES

The present invention will be understood more fully from the detailed description that follows and from the accompanying drawings, which however, should not be taken to limit the disclosed subject matter to the specific embodiments shown, but are for explanation and understanding only.

FIG. 1 illustrates an embodiment of the invention disclosed.

FIG. 2 illustrates an embodiment of the image capturing system disclosed.

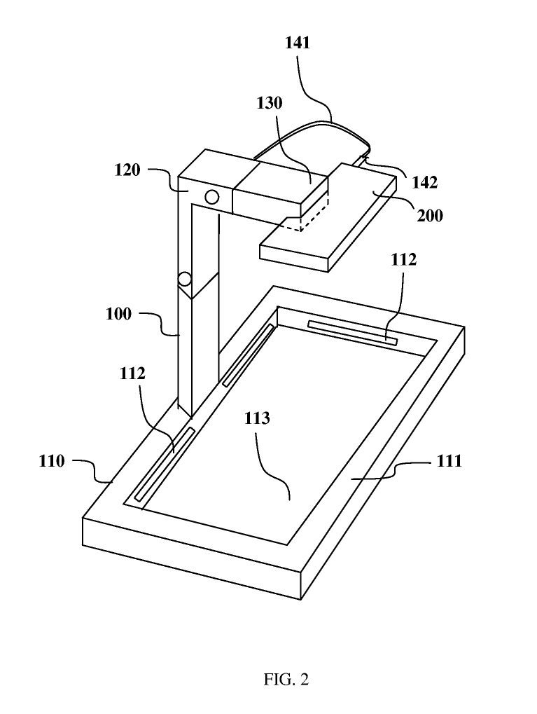

### DETAILED DESCRIPTION OF THE INVENTION

The object of this invention is a method for providing bookkeeping service for a number of organizations by a number of remote bookkeepers with some security concerns addressed.

The method requires facilitation of a bookkeeping server that both authorized clerks of organizations and remote bookkeepers can access via the Internet. The general workflow comprises the following steps: authorized clerks of organizations upload work items produced by general clerks of the organizations to the bookkeeping server; remote bookkeepers process the work items on the bookkeeping server; and the authorized clerks approve the processed work items.

In our preferred embodiment, some security concerns of using remote bookkeepers are addressed using techniques comprising: (1) secure client sessions (2) work item distribution; (3) organization information concealment; (4) encryption using organization specific private keys; (5) concealment of passwords; and (6) distributed storage. We shall elaborate on the techniques herein.

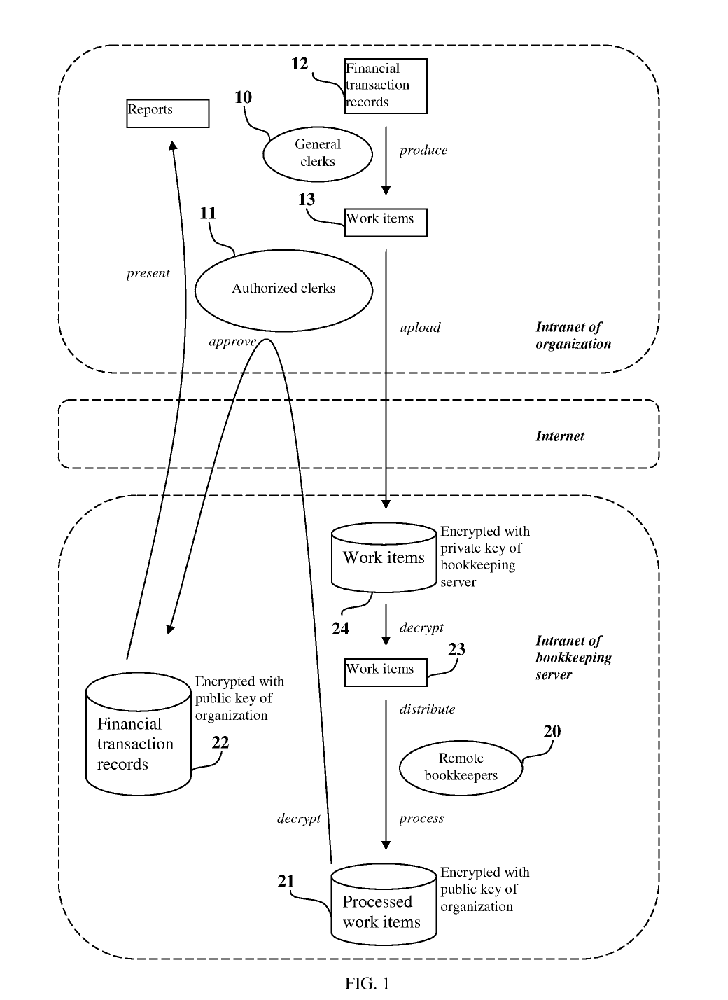

In our preferred embodiment, as in FIG. 1, there are two roles in an organization: general clerks 10 and authorized clerks 11. A general clerk and an authorized clerk can be the same person when the person is playing two roles. We consider general clerks 10 of an organization being the producers or providers of work items 13 for bookkeeping. The general clerks may or may not be the originators of the financial transaction records 12, but they help capture the financial transaction records 12 into digital images as work items 13 that can be processed electronically. The general clerks 10 do not have authorization to access the bookkeeping server while the authorized clerks 11 do. The general clerks 10 may first submit their work items 13 to a server under the administration of the organization. The authorized clerks can upload the work items on the server of the organization to the bookkeeping server via a secure client session with a password only known to the authorized clerks 11. Alternatively, if the same person plays both the general clerk and authorized clerk roles, the person can produce the work items 13 and upload the work items 13, without using an intermediate server of the organization, to the bookkeeping server via a secure client session. Therefore the data of the organization are protected during the data transfer to the bookkeeping server.

The remote bookkeepers 20 can access the work items 23 on the bookkeeping server securely if their computers are on the same private network as the bookkeeping server. A less desirable embodiment is to have remote bookkeepers 20 create secure client sessions to the bookkeeping server if their computers need to reach the bookkeeping server via the Internet. Once again, the data of the organization are protected from the public during the remote bookkeepers 20 accessing the work items 23.

Some techniques disclosed in this invention are meant to hide as much information as possible from remote bookkeepers lest they would use the information for personal gain. Firstly, the bookkeeping server distributes work items 23 to remote bookkeepers 20 in such a way that a remote bookkeeper receives work items from a number of organizations and a remote bookkeeper never receives all work items from one organization. The purpose is not to have a remote bookkeeper possess complete knowledge about an organization.

Secondly, the bookkeeping server blocks out the information about the organization when displaying an image of a financial transaction record as a work item to a remote bookkeeper. For example, a work item is an invoice from a supplier to an organization. The name and address of the organization is known to the bookkeeping server as the work item is uploaded by authorized clerks of the organization. The bookkeeping server can perform optical character recognition (OCR) on the image of the work item and identify the portion of the image that contains the name and address of the organization. Then the bookkeeping server blocks out that portion of the image when displaying the image to a remote bookkeeper. The bookkeeping server can easily associate the processed work item to the organization. By organization information concealment, it is more difficult for a remote bookkeeper to make sense of the financial transaction record for personal gain.

There are some techniques disclosed in this invention aiming at protecting information of organization from perpetrators who somehow have gained access to the bookkeeping server. Firstly, the password of authorized clerks 11 of the organization for creating a secure client session is stored on the bookkeeping server in an encrypted form. The bookkeeping server is able to authenticate the authorized clerks 11 using the password in the encrypted form, but the perpetrators are not able to see the password in clear text. That is a well-known technique in Linux system.

Secondly, the authorized clerks 11 are to supply a pair of public key and private key to the bookkeeping server via the secure client session. The bookkeeping server shall keep the private key briefly but keep the public key permanently. The bookkeeping server keeps a database 22 for each organization. Each database 22 is encrypted using the public key supplied by the authorized clerks 11 of the organization. Accessing the encrypted database 22 requires the private key for decryption. The work items 13 uploaded via the secure client session are first processed by the automation logics for processing the work items 13 during which the bookkeeping server needs the private key for accessing the encrypted database 22. Then the bookkeeping server encrypts the work items 13 using a key generated by the bookkeeping server and saves the encrypted work items 24 for the remote bookkeepers 20 to process. When the remote bookkeepers 20 are ready to process the work items 24, the bookkeeping server decrypts the work items 24 using the key generated by the bookkeeping server and presents the work items 23 to the remote bookkeepers. After the remote bookkeepers process the work items 23, the bookkeeping server encrypts the processed work items 21 using the public key of the organization and saves the processed work items 21 for the authorized clerks 11 to approve. When the authorized clerks 11 are ready to approve the processed work items 21, which may be through a secure client session different from the one for uploading the work items 13, the bookkeeping server decrypts the processed work items 21 and the database 22 using the private key supplied by the authorized clerks 11. After the approval of the work items 21, the bookkeeping server updates the database 22 and encrypts the database 22 using the public key. The bookkeeping server needs and caches the private key only during the authorized clerks uploading the work items, approving the processed work items, or accessing the database. The private key is never stored outside the context of a secure client session. Therefore, the perpetrators are not able to access the database of any organization. Even if one database of an organization is compromised in security, the databases of other organizations are still protected.

Thirdly, the bookkeeping server comprises a computing cluster capable of distributed processing and distributed storage in our preferred embodiment. For example, the bookkeeping server runs its software over the Hadoop framework. A number of parts of the database of any organization are stored on and spread across a number of computers in the computing cluster. Even if a computer in the computing cluster is compromised in security, not the whole database is compromised.

The bookkeeping server sometimes requires the private key, supplied by authorized clerks 11 of an organization via a secure client session, to modify the database 22 of the organization. The bookkeeping server never saves the private key permanently. The bookkeeping server is not to expose the private key to any administrator or any programmer of the bookkeeping server. That has to be made sure through code inspection of software running on the bookkeeping server. There must be no backdoor for anyone to get hold of the private key.

The bookkeeping server can automate the processing of work items as much as possible. It can perform optical character recognition (OCR) on the image of a work item and process the work item according to how similar work items have been processed by remote bookkeepers and approved by authorized clerks. Remote bookkeepers may just confirm the results of automatic processing or manually process the work items at their discretion. In fact, if there is high confidence on the results of automatic processing of some work items, the bookkeeping server can skip the remote bookkeepers on those work items, hence keeping more information away from the remote bookkeepers.

We shall further present an image capturing system herein. The image capturing system facilitates capturing images of a large number of financial transaction records, printed or written. The image capturing system presented shall not be viewed as a limitation on how the method in this invention is practiced because the method can be practiced even when the images of financial transaction records are computer generated. Also, the method can be practiced when images of financial transaction records are captured by other means, such as using a scanner or a digital camera. The image capturing system presented is just our preferred embodiment of a means that facilitates capturing images of financial transaction records in printed or written form.

The image capturing system is meant to be low-cost. It comprises a smart phone 200 and a holder 100 of the smart phone 200. Many people purchase smart phones for multiple purposes. Smart phones comprise high resolution camera, networking capability, and text editing capability. They can be leveraged to capture images of financial transaction records. Capturing document images using camera is faster than capturing document images using a scanner. On the other hand, the lighting control is often a challenge. Document images captured by camera of smart phone often exhibit shades and uneven lighting. The image capturing system herein is meant to alleviate the problem.

The holder 100 of smart phone comprises a basket 110 that can contain a letter-sized or legal-sized document. The basket 110 is therefore rectangular in shape. The basket 110 has four sidewalls 111. There are lights 112 along the sidewalls 111 to provide illumination to a document placed inside the basket 110. The lights 112 are controlled by an electronic device embedded in a sidewall. In our preferred embodiment, the electronic device comprises an audio cable 141 with audio plug 142 at the end. The electronic device further comprises an audio signal decoder such that when there are audio signals received on the audio cable 141, the audio signal decoder turns on the lights 112. When there is no audio signal received on the audio cable 141, the audio signal decoder turns off the lights 112. The audio plug 142 of the audio cable 141 is to be connected to the audio jack of the smart phone 200 such that the image capturing software running on the smart phone 200 can switch the lights 112 on and off by generating and not generating audio signals, respectively. The primary motivation of making the electronic device capable of using audio signals from the smart phone 200 to control the lights 112 is cost. There can be other embodiments of the electronic device. For example, the electronic device is made to support Bluetooth so that the smart phone 200 can control the lights 112 by sending commands through the Bluetooth communication channel.

The holder 100 further comprises an elbow 120 attached to and stabilized on a sidewall of the basket 110. The end of the elbow 120 is a clamp 130. Users may affix the smart phone 200 to the clamp 130. The elbow 120 is manually adjustable vertically and horizontally. The elbow 120 holds the smart phone above the basket 110 such that the camera of the smart phone 200 is facing the basket 110. Users may adjust the elbow 120 so that the camera may capture an image of the basket 110 and a document therein.

The elbow 120 is hollow and allows electric cables to run through and to be concealed cosmetically. In our preferred embodiment, a sidewall of the basket 110 embeds a power adapter. An electric cable from the power adapter can be plugged into an AC outlet. The power adapter provides power to the lights 112 and the electronic device that controls the lights 112. Also, the power adapter can provide power to the smart phone 200 clamped on the elbow 120. For that purpose, an electric cable from the power adapter is run through the elbow 120 to reach the smart phone's charging inlet. Also, the audio cable 141 from the electronic device runs through the elbow 120 to reach the smart phone's audio jack.

The basket 110 is designed to facilitate image processing performed by image capturing software on the smart phone 200. The basket's bottom 113 is in a non-white solid color, e.g., yellow, whereas the basket's sidewalls 111 are in a different non-white solid color, e.g., green. When the image capturing software captures an image of the basket 110 and the document therein, the image may include the sidewalls 111 and the bottom 113, especially when the document is smaller than the basket 110. The image capturing software can easily identify the portion of the image that represents the bottom 113 and the sidewalls 111, due to their unique colors, and crop the image to a minimal size that contains the document only.

The image capturing software running smart phone 200 can facilitate the image capturing process using image processing techniques. Firstly, the image capturing software can assist in positioning the camera properly using the following steps: (1) user initiates the image capturing software to enter set-up mode; (2) the image capturing software turns on the lights 112 by generating audio signals; (3) user adjust the elbow 120 to position the smart phone 200 vertically and horizontally over the basket 110; (4) when the image capturing software detects all four sidewalls 111 of the basket 110 being within the image field, it switches off the lights 112 by stopping sending audio signals; (5) the image capturing software then exits the set-up mode.

Secondly, the image capturing software can provide convenience in capturing images of documents using the following steps: (1) the image capturing software flashes the lights 112 once by sending audio signals for a brief moment when it detects a user placing a document inside the basket 110 through motion detection in images captured by the camera; (2) the image capturing software turns on the lights 110 by sending audio signals when it detects user motion being ceased for a while; (3) the image capturing software stores an image of the document placed inside the basket 110; (4) the image capturing software turns off the lights 112 by stopping sending audio signals. The steps facilitate users repeatedly putting documents one by one into the basket 110 for image capturing.

Thirdly, the image capturing software can facilitate users to create annotations to the images captured. The annotations may comprise instructions for remote bookkeepers on how to process the financial transaction records. The annotations can be textual, inputted through the touchscreen of the smart phone 200. The annotations could be audio clips recorded through the smart phone 200.

Lastly, the image capturing software can upload the images, with their annotations, as work items 13 to a server of the organization or a remote bookkeeping server, at the discretion of users.

The embodiments described above are illustrative examples and it should not be construed that the present invention is limited to these particular embodiments. Thus, various changes and modifications may be effected by one skilled in the art without departing from the spirit or scope of the invention as defined in the appended claims.

1. A method for providing bookkeeping service for an organization, of a plurality of organizations, using remote bookkeepers, with facilitation of a bookkeeping server, comprising:
(a) in said bookkeeping server, operating a program that allows authorized clerks of said organization to upload images of financial transaction records that are provided by general clerks of said organization as work items to said bookkeeping server via a secure client session;
(b) distributing said work items to a plurality of remote bookkeepers;
(c) allowing said remote bookkeepers to process said work items on said bookkeeping server; and
(d) allowing authorized clerks of said organization to approve processed work items on said bookkeeping server via a secure client session.

2. The method as in claim 1, wherein said general clerks may upload said images to a server of said organization and let said authorized clerks upload said images from said server of said organization to said bookkeeping server.

3. The method as in claim 1, wherein said authorized clerks use a password only known to said authorized clerks to create a secure client session to said bookkeeping server for uploading said images to said bookkeeping server as work items, for approving processed work items stored on said bookkeeping server, and for accessing all records specific to said organization on said bookkeeping server.

4. The method as in claim 1, wherein said general clerks or said authorized clerks may create annotations to said images as part of said work items.

5. The method as in claim 1, wherein said bookkeeping server comprises a computing cluster capable of distributed processing and distributed storage and distributes records specific to said organization to a plurality of computers in said computing cluster for storage.

6. The method as in claim 1, wherein said bookkeeping server can automatically process said work items on behalf of said remote bookkeepers, according to work items' contents identified via optical character recognition and how similar work items have been processed and approved.

7. The method as in claim 1, wherein said bookkeeping server distributes said work items to a plurality of remote bookkeepers in such a way that a remote bookkeeper receives work items belonging to a plurality of organizations and never receives all work items belonging to one specific organization.

8. The method as in claim 1, wherein said remote bookkeepers may log on to said bookkeeping server at the time of their choosing to process said work items when computers of said remote bookkeepers are on the same private network as said bookkeeping server.

9. The method as in claim 1, wherein said remote bookkeepers may create secure client sessions to said bookkeeping server at the time of their choosing to process said work items.

10. The method as in claim 1, wherein said remote bookkeepers may confirm processed work items that have been automatically processed by said bookkeeping server or process said work items using discretion.

11. The method as in claim 1, wherein said bookkeeping server can mask some portions of said images to conceal information about said organization when displaying said images to said remote bookkeepers.

12. The method as in claim 1, wherein said authorized clerks supply a pair of public key and private key of said organization via said secure client session for said bookkeeping server to encrypt processed work items using said public key of said organization, to decrypt processed work items using said private key of said organization when presenting processed work items to said authorized clerks for approval, and to decrypt an encrypted database of said organization and then encrypt said database after adding approved processed work items to said database using said private key and said public key of said organization, respectively.

13. The method as in claim 1, wherein said bookkeeping server encrypts said work items using a private key of said bookkeeping server for storage and decrypts said work items using said private key of said bookkeeping server when presenting said work items to said remote bookkeepers.

14. An image capturing system for capturing images of financial transaction documents, comprising:
(a) a smart phone comprising:
i. an image capturing application; and
ii. at least one camera; and
(b) a holder of said smart phone comprising:
i. a basket, comprising a bottom and a plurality of sidewalls, that can contain at least one document;
ii. lights on said sidewalls of said basket that can provide illumination on document placed inside said basket;
iii. an adjustable elbow stabilized on said basket; and
iv. a clamp at the end of said elbow, wherein said clamp holds said smart phone such that said camera of said smart phone faces said basket.

15. The image capturing system as in claim 14, wherein said elbow comprises a plurality of segments, and when said segments are disassembled they can fit inside said basket for efficient packaging.

16. The image capturing system as in claim 14, wherein said elbow is hollow and allows electric cables to run through at least for providing power to said smart phone from a power adapter as part of said basket.

17. The image capturing system as in claim 14, wherein said holder further comprises an electronic device that switches said lights on and off.

18. The image capturing system as in claim 17, wherein said electronic device comprises an audio cable with a plug at the end of said audio cable and a decoder of audio signals received from said audio cable, such that said lights are turned on during the presence of audio signals.

19. The image capturing system as in claim 18, wherein said audio cable is plugged into an audio jack of said smart phone such that said image capturing application of said smart phone can switch on and off said lights by sending and not sending audio signals, respectively.

20. The image capturing system as in claim 14, wherein said image capturing application captures an image of a document placed inside said basket comprising the steps of:
(a) flashing the lights once when it detects a user placing a document inside said basket through image processing techniques;
(b) turning on the lights when it detects user motion has stopped;
(c) capturing an image of said document placed inside said basket; and
(d) turning off the lights.

21. The image capturing system as in claim 14, wherein said image capturing application permits users to create annotations associated with said images.

22. The image capturing system as in claim 14, wherein said sidewalls of said basket are in a solid non-white color while the bottom of said basket are in a different solid non-white color.

23. The image capturing system as in claim 14, wherein setting up said image capturing system by a user to capture images of financial transaction documents properly comprising the steps of:
(a) user initiating said image capturing application to enter set-up mode;
(b) said image capturing application turning on the lights;
(c) user adjusting the joints of the elbow to position said smart phone vertically and horizontally;
(d) said image capturing application turning off the lights when it detects all sidewalls of said basket can be captured by said camera; and
(e) said image capturing application exiting set-up mode;

24. The image capturing system as in claim 14, wherein said image capturing application further crops said images to a minimal size by removing the image portions that represent the bottom and said sidewalls of said basket.
